(19) United States
(12) Patent Application Publication
(10) Pub. No.: US 2026/0365517 A1
(43) Pub. Date: Nov. 19, 2026

(54) Hard Carbon and Method for Producing Hard Carbon

(71) Applicant: NTT, Inc., Tokyo (JP)

(72) Inventors: Masaya Nohara, Musashino-shi, Tokyo (JP); Sho Okubo, Musashino-shi, Tokyo (JP); Shuhei Sakamoto, Musashino-shi, Tokyo (JP); Masahiko Hayashi, Musashino-shi, Tokyo (JP); Hiroaki Taguchi, Musashino-shi, Tokyo (JP); Atsushi Aratake, Musashino-shi, Tokyo (JP)

(21) Appl. No.: 19/126,556

(22) PCT Filed: Dec. 20, 2022
(86) PCT No.: PCT/JP2022/046924

§ 371 Date: May 1, 2025

(51) Int. Cl. C01B 32/05; C01B 32/205; H01M 4/587

(52) U.S. Cl. CPC C01B 32/05; C01B 32/205; C01P 2006/40; H01M 4/587

(57) ABSTRACT

Provided is a method for producing hard carbon, the method including: freezing a dispersion or gel containing cellulose nanofibers to obtain a frozen body; drying the frozen body in a vacuum to obtain a dried body; heating and carbonizing the dried body in a non-combustible atmosphere to obtain amorphous carbon derived from cellulose nanofibers; and heating the amorphous carbon in a non-combustible atmosphere while applying pressure to grow graphite crystals to obtain hard carbon derived from cellulose nanofibers.

### TECHNICAL FIELD

The present disclosure relates to hard carbon and a method for producing hard carbon.

### BACKGROUND ART

As a disposable primary battery and a rechargeable secondary battery, alkaline batteries, manganese batteries, high-performance coin-type lithium primary batteries, nickel-cadmium batteries, nickel-metal hydride batteries, lithium ion batteries, and the like have been used conventionally in small devices, sensors, mobile devices, and the like.

Among them, lithium ion batteries are widely used due to their high capacity, high voltage, small size, and light weight. Furthermore, in recent years, from the viewpoint of resource risks, research and development has been actively conducted on sodium ion batteries, potassium ion batteries, magnesium ion batteries, calcium ion batteries, aluminum ion batteries, and other batteries that do not use lithium as a rare metal.

These ion batteries may be required to have excellent high-speed charge/discharge characteristics depending on the application. In order to obtain an ion battery with excellent high-speed charge/discharge characteristics, studies have been conducted on improving the diffusion rate of ions received on the surface of the active material is improved by micronizing the negative electrode active material and increasing the active material surface area (Non Patent Literature 1).

In addition, with the recent development of the Internet of Things (IoT), various objects around us are being turned into devices, and furthermore, the development of scattered sensors that are installed throughout the natural world, such as in soil and forests, is also progressing. Therefore, when selecting battery materials, it is necessary to take into consideration the environmental load and resource risks (Patent Literature 1).

### CITATION LIST

### Patent Literature

Patent Literature 1: JP 6711915 B2

### Non Patent Literature

Non Patent Literature 1: Afshin Pendashteh, Brahim Orayech, Hugo Suhard, Maria Jauregui, Jon Ajuria, Begona Silvan, Skye Clarke, Francisco Bonilla, Damien Saurel, Boosting the performance of soft carbon negative electrode for high power Na-ion batteries and Li-ion capacitors through a rational strategy of structural and morphological manipulation, Energy Storage Materials 46 (2022) 417-430, doi: 10.1016/j.ensm.2022.01.030

### SUMMARY OF INVENTION

### Technical Problem

As described in Non Patent Literature 1, the high-speed charge/discharge characteristics can certainly be improved by micronizing the negative electrode active material. However, micronizing the negative electrode active material causes the gaps between the active material particles to become too many, resulting in a decrease in the number of conductive paths. Furthermore, as the conductive paths decrease, the overvoltage areas increase, which causes problems such as a decrease in charge/discharge capacity and a decrease in cycle characteristics.

In addition, it is known that the negative electrode active material expands and contracts due to the insertion and removal of ions during charging and discharging, and this expansion and contraction can cause cracking of the negative electrode active material and deactivation due to disconnection of the conductive path.

Moreover, the negative electrode active materials of ion batteries currently in general use are composed of either natural graphite, artificial graphite, or hard carbon (non-graphitizable carbon). Natural graphite relies on import from a very limited number of countries, such as China, and its availability is greatly affected by overseas situations, resulting in a high resource risk. Artificial graphite and hard carbon are also currently made from coal and petroleum, and these also have the problem of large price fluctuations due to overseas situations.

The present disclosure has been made in consideration of the above circumstances, and an object of the present disclosure is to provide hard carbon capable of preventing a decrease in the number of conductive paths by using raw materials with a low resource risk.

### Solution to Problem

According to an aspect of the present disclosure, there is provided a method for producing hard carbon, the method including: freezing a dispersion or gel containing cellulose nanofibers to obtain a frozen body; drying the frozen body in a vacuum to obtain a dried body; heating and carbonizing the dried body in a non-combustible atmosphere to obtain amorphous carbon derived from cellulose nanofibers; and heating the amorphous carbon in a non-combustible atmosphere while applying pressure to grow graphite crystals to obtain hard carbon derived from cellulose nanofibers.

According to another aspect of the present disclosure, there is provided hard carbon including: a three-dimensional network structure in which cellulose nanofibers are branched and connected cocontinuously; and a hexagonal plate-like layered crystal structure of carbon into which ions are insertable and removable.

According to still another aspect of the present disclosure, there is provided hard carbon including: a three-dimensional network structure in which nanofibers of a bacteria-produced gel are branched and connected cocontinuously; and a hexagonal plate-like layered crystal structure of carbon into which ions are insertable and removable.

### Advantageous Effects of Invention

According to the present disclosure, it is possible to provide hard carbon capable of preventing a decrease in the number of conductive paths by using raw materials with a low resource risk.

### BRIEF DESCRIPTION OF DRAWINGS

FIG. 1 is a flowchart showing a method for producing hard carbon derived from cellulose nanofibers according to a first embodiment.

FIG. 2A is an SEM image of hard carbon derived from cellulose nanofibers produced using the production method according to the first embodiment.

FIG. 2B is an SEM image of hard carbon derived from cellulose nanofibers produced using a production method different from that of the first embodiment.

FIG. 3 is a flowchart showing a method for producing hard carbon derived from bacteria-produced cellulose according to a second embodiment.

FIG. 4A is an SEM image of hard carbon derived from bacteria-produced cellulose produced using the production method according to the second embodiment.

FIG. 4B is an SEM image of a carbon material produced using a production method different from that of the second embodiment.

FIG. 5 is a schematic cross-sectional view illustrating a structure of a coin-type battery.

### DESCRIPTION OF EMBODIMENTS

Hereinafter, embodiments of the present disclosure will be described with reference to the drawings.

### First Embodiment

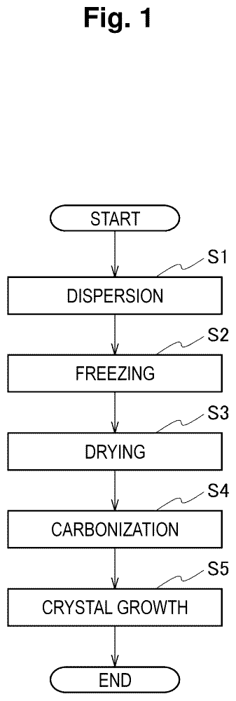

FIG. 1 is a flowchart showing a method for producing hard carbon derived from cellulose nanofibers according to a first embodiment of the present disclosure. In the following description, “hard carbon derived from cellulose nanofibers” may also be referred to as “hard carbon”.

The method for producing hard carbon of the present embodiment includes a dispersion step (step S1), a freezing step (step S2), a drying step (step S3), a carbonization step (step S4), and a crystal growth step (step S5). In this production method, a cellulose nanofiber dispersion is required.

The cellulose nanofibers in the cellulose nanofiber dispersion are preferably in a dispersed state. Therefore, although the production step shown in FIG. 1 includes a dispersion step (step S1), this dispersion step (step S1) may be omitted. In other words, when using a dispersion in which cellulose nanofibers are dispersed, this step is not necessary.

The dispersion step, the cellulose nanofibers contained in a cellulose nanofiber dispersion are dispersed (step S1). A dispersion medium is an aqueous system such as water (H₂O), or an organic system such as carboxylic acids, methanol (CH₃OH), ethanol (C₂H₅OH), propanol (C₃H₇OH), n-butanol, isobutanol, n-butylamine, dodecane, unsaturated fatty acids, ethylene glycol, heptane, hexadecane, isoamyl alcohol, octanol, isopropanol, acetone, or glycerin, and two or more kinds thereof may be mixed.

The cellulose nanofibers may be dispersed using, for example, a homogenizer, an ultrasonic cleaner, an ultrasonic homogenizer, a magnetic stirrer, an agitator, a shaker, or the like.

The solids concentration of the cellulose nanofibers in the cellulose nanofiber dispersion is preferably 0.001 to 80% by mass, and more preferably 0.01 to 30% by mass.

In the freezing step, the dispersion containing the cellulose nanofibers is frozen to obtain a frozen body (step S2). This step is carried out, for example, by storing the cellulose nanofiber dispersion in a suitable container, such as a test tube, and cooling the surroundings of the test tube in a coolant, such as liquid nitrogen, to freeze the cellulose nanofibers stored in the test tube.

The freezing method is not particularly limited as long as the dispersion medium of the dispersion can be cooled to a temperature equal to or lower than the freezing point. The dispersion medium may be cooled in a freezer or the like. By freezing the cellulose nanofiber dispersion, the dispersion medium loses its fluidity, the cellulose nanofibers, which are dispersoids, are fixed, and a three-dimensional network structure in which the cellulose nanofibers are connected cocontinuously is constructed.

In the drying step, the frozen body frozen in the freezing step is dried in a vacuum to obtain a dried body (step S3). In this step, the frozen dispersion medium is sublimated from a solid state. For example, the obtained frozen body is stored in an appropriate container, such as a flask, and the inside of the container is evacuated to a vacuum. By disposing the frozen body in a vacuum atmosphere, the sublimation point of the dispersion medium is lowered, and even a substance that is not sublimated at normal pressure can be sublimated.

The degree of vacuum in the drying step varies depending on the dispersion medium to be used, but is not particularly limited as long as it is a degree of vacuum at which the dispersion medium sublimates. For example, when water is used as the dispersion medium, it is necessary to set the degree of vacuum to a pressure of 0.06 MPa or less, but since heat is removed as latent heat of sublimation, it takes time for drying. In view of this, the degree of vacuum is preferably 1.0×10⁻⁶ Pa to 1.0×10⁻² Pa. Furthermore, heat may be applied using a heater or the like during drying.

In the carbonization step, the dried body dried in the drying step is heated and carbonized in a non-combustible atmosphere to obtain amorphous carbon derived from cellulose nanofibers (step S4). In the following description, “amorphous derived from cellulose nanofibers” may also be referred to as “amorphous carbon”.

The cellulose nanofibers may be carbonized through heat treatment in an inert gas atmosphere at 200 °C to 2000 °C, more preferably at 600 °C to 1800 °C. A gas that does not burn cellulose may be, for example, an inert gas, such as nitrogen gas or argon gas. The gas that does not burn cellulose may be a reducing gas, such as hydrogen gas or carbon monoxide gas, or may be carbon dioxide gas. From the viewpoint of cost, inexpensive nitrogen gas is more preferable.

In the crystal growth step, the amorphous carbon carbonized in the carbonization step is heated again in a non-combustible atmosphere while applying pressure to grow graphite crystals to obtain hard carbon derived from cellulose nanofibers (step S5).

The hard carbon of the present embodiment has: a three-dimensional network structure in which cellulose nanofibers are branched and connected cocontinuously; and a hexagonal plate-like layered crystal structure of carbon into which ions are insertable and removable.

Generally, amorphous carbon does not have a layered structure of connected six-membered carbon rings like graphite, and therefore ions cannot be inserted or removed between the layers of the six-membered carbon rings, and thus cannot be used as a negative electrode active material. Therefore, in the present embodiment, heat treatment is performed at 1200 °C to 3500 °C to promote the crystal growth of graphite and obtain hard carbon suitable for the negative electrode active material of ion batteries.

Amorphous carbon derived from cellulose nanofibers has a three-dimensional network structure with fiber diameters of several tens of nanometers, and because the amorphous carbon is in a coarse state, there is a limit to the crystal growth of graphite even when heat treatment is performed at high temperatures.

Therefore, in the present embodiment, the amorphous carbon is subjected to a heat treatment while pressure is applied, so that the fibrous amorphous carbons are brought into contact with each other, and the crystal growth of graphite is promoted. By bringing fibrous amorphous carbons into contact with each other and heat treating it, the crystal growth of graphite is promoted. Therefore, the fiber diameter of the hard carbon after the crystal growth step is greater than the fiber diameter of the amorphous carbon before the crystal growth step, but the three-dimensional network structure is still maintained in the hard carbon after the crystal growth step. Accordingly, in the present embodiment, it is possible to produce hard carbon having a large active material surface area and a high diffusion rate of ions received on the surface of the active material. Therefore, the hard carbon of the present embodiment is suitable as a negative electrode active material for an ion battery.

In addition, since the hard carbon of the present embodiment has a three-dimensional network structure, the active materials are continuous with each other, and have a very high conductive path. Furthermore, joint portions between the carbon fibers (carbonized cellulose nanofibers) of hard carbon are branched and act as springs, giving a stretchability. In other words, the three-dimensional network structure of the present embodiment is formed by the joint portions between the cellulose nanofibers branching and entangling to be connected cocontinuously, which gives the hard carbon of the present embodiment elasticity and a restoring force. Therefore, it is also possible to withstand the expansion and contraction that accompanies the insertion and removal of ions during charging and discharging, and the negative electrode active material does not crack and the conductive paths do not break.

Crystal growth of amorphous carbon derived from cellulose nanofibers may be achieved by carbonizing the material through heat treatment in an inert gas atmosphere at 1200 °C to 3500 °C, more preferably at 1500 °C to 3000 °C. A gas that does not burn amorphous carbon may be, for example, an inert gas, such as nitrogen gas or argon gas. The gas that does not burn amorphous carbon may be a reducing gas, such as hydrogen gas. From the viewpoint of cost, inexpensive nitrogen gas is more preferable, but typically, a more inert argon gas is used in equipment that performs heat treatment at such high temperatures.

The pressure applied during the heat treatment varies greatly depending on the amount of amorphous carbon, particularly the thickness in the direction in which the pressure is applied. Specifically, the pressure may be adjusted so that the thickness of the amorphous carbon in the direction in which the pressure is applied is ½ to 1/100, more preferably 1/10 to 1/50.

This is because if the pressure is too low, the crystals cannot grow and the material cannot function as a negative electrode active material, whereas if the pressure is too high, the three-dimensional network structure is crushed by sintering during the heat treatment.

The method of applying pressure is not particularly limited, but pressure can be easily applied by placing a weight made of ceramic, graphite, or the like on the amorphous carbon. Graphite is preferred since it has the same composition as the hard carbon, which is an object to be produced in the present disclosure. Therefore, in the crystal growth step, it is preferable to place graphite on the amorphous carbon and apply pressure to the amorphous carbon.

In addition, pressure may be applied to the amorphous carbon during the crystal growth step using a screw-type sealed crucible. That is, a screw-type sealed crucible can be used, and pressure can be applied by pushing in the lid until the thickness of the amorphous carbon becomes ½ to 1/100, more preferably 1/10 to 1/50. The screw-type sealed crucible includes a lid portion and a container portion, and the lid portion has a pressure application part that can be inserted into the inside (bottom portion) of the container portion. Amorphous carbon is stored in the container portion. By closing the lid portion, pressure is applied to the screw-type sealed crucible in the container portion, and the amorphous carbon is crushed.

In general, in graphitizing carbon materials and organic substances, pressure is applied to the carbon materials and organic substances to form them before heat treatment for crystal growth, and then heat treatment is performed. However, because amorphous carbon derived from cellulose nanofibers has stretchability, even if pressure is applied temporarily, it will return to its original shape once the pressure application is stopped, and the effect of applying pressure before heat treatment will not last.

Even if pressure is applied during heat treatment when graphitizing general carbon materials and organic substances, a small pressure such as that applied by placing a weight made of ceramic or graphite on the material is ineffective. Therefore, it is necessary to apply a large amount of pressure using a press or a jig, but it is difficult to obtain a press or a jig that can withstand high temperatures of 1200 °C to 3500 °C, and there is currently no way to do this.

Even if a screw-type sealed crucible is used, screw-type sealed crucibles that can withstand high temperatures of 1200 °C to 3500 °C are made of graphite, and if a graphite screw-type sealed crucible is exposed to high temperatures while a large pressure is applied, it will expand and crack or the like. Therefore, screw-type sealed crucibles are not usually used for the purpose of applying pressure.

On the other hand, amorphous carbon derived from cellulose nanofibers has stretchability as mentioned above, and contracts sufficiently even with a weight made of ceramic or graphite, so that even a small pressure of 10 N/cm² is effective in promoting crystal growth. The applied pressure is preferably 10 to 100 kN/cm².

Furthermore, as described above, since the effect is sufficient even with a small pressure, even if a screw-type sealed crucible is used and the amorphous carbon derived from cellulose nanofibers is exposed to high temperatures while pressure is being applied, the screw-type sealed crucible will not be damaged.

According to the above-mentioned method for producing hard carbon derived from cellulose nanofibers, the cellulose nanofibers, which are dispersoids, are fixed by the freezing step, and a three-dimensional network structure is constructed. Furthermore, the drying step allows the extraction of cellulose nanofibers while maintaining their three-dimensional network structure. Therefore, a sufficient specific surface area can be obtained, and a continuous, stretchable negative electrode active material can be produced.

Furthermore, in the crystal growth step, a hexagonal plate-like layered crystal structure of carbon into which ions are insertable and removal, can be formed.

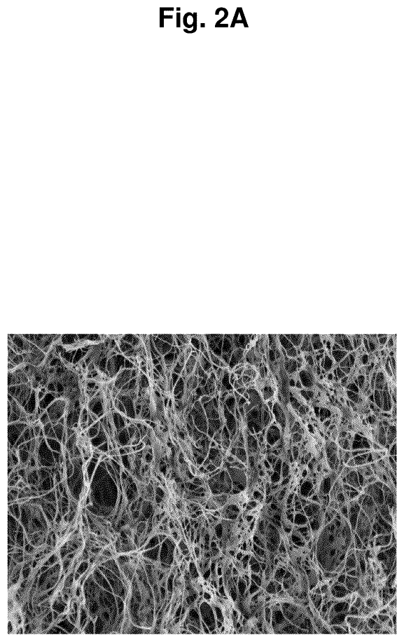

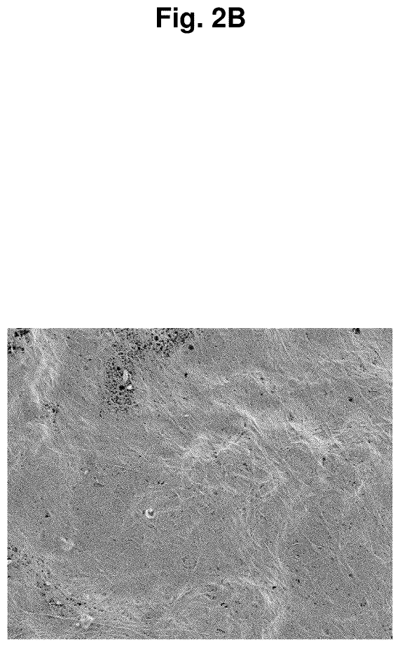

FIGS. 2A and 2B are scanning electron microscope (SEM) images of hard carbon derived from cellulose nanofibers. The magnification is 10,000 times.

FIG. 2A is an SEM image of hard carbon derived from cellulose nanofibers produced using the production method of the present embodiment. From the image, it can be seen that the cellulose nanofibers are fixed and a three-dimensional network structure is constructed.

FIG. 2B shows the state of hard carbon derived from cellulose nanofibers in a case where the cellulose nanofibers are dried and carbonized in the atmosphere, which is different from the production method of the present embodiment. As the frozen body changes from solid to liquid and then from liquid to gas, the three-dimensional network structure of the cellulose nanofibers is destroyed. As shown in FIG. 2B, if the three-dimensional network structure is destroyed, it becomes difficult to produce hard carbon with a high specific surface area.

As described above, the hard carbon derived from cellulose nanofibers produced using the production method of the present embodiment is hard carbon having a continuous three-dimensional network structure in which cellulose nanofibers are connected and having stretchability. Furthermore, the hard carbon derived from cellulose nanofibers of the present embodiment has high electrical conductivity, corrosion resistance, and a high specific surface area.

Therefore, the hard carbon derived from cellulose nanofibers produced using the production method of the present embodiment is suitable not only as a negative electrode material for ion batteries, but also as batteries, capacitors, fuel cells, biofuel cells, microbial batteries, catalysts, solar cells, semiconductor manufacturing processes, medical equipment, beauty tools, filters, heat-resistant materials, flame-resistant materials, heat insulating materials, conductive materials, electromagnetic wave shielding materials, electromagnetic noise absorbing materials, heating elements, microwave heating elements, corn paper, clothing, carpets, anti-fogging mirrors, sensors, touch panels, etc.

### Second Embodiment

In a second embodiment, a gel containing cellulose nanofibers is used instead of the dispersion containing cellulose nanofibers of the first embodiment. Moreover, the gel of the second embodiment is a bacteria-produced gel in which cellulose nanofibers are dispersed using bacteria. Therefore, in the following description, the hard carbon derived from cellulose nanofibers produced using the production method according to the second embodiment will be referred to as hard carbon derived from bacteria-produced cellulose. In the following description, “hard carbon derived from bacteria-produced cellulose” may also be referred to as “hard carbon”.

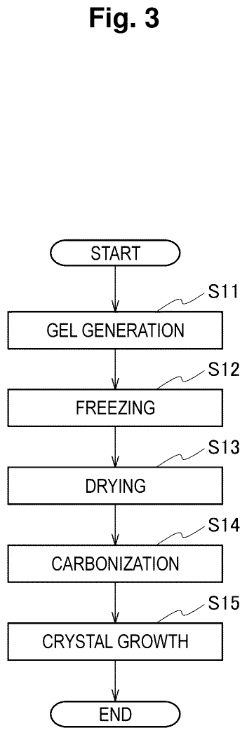

FIG. 3 is a flowchart showing a method for producing hard carbon derived from bacteria-produced cellulose according to the second embodiment of the present disclosure.

The method for producing hard carbon derived from bacteria-produced cellulose of the present embodiment includes a gel generation step (step S11), a freezing step (step S12), a drying step (step S13), a carbonization step (step S14), and a crystal growth step (step S15).

The gel generation step includes using bacteria to generate a bacteria-produced gel in which cellulose nanofibers are dispersed (step S11). Here, a gel refers to a dispersion medium that loses fluidity and becomes solid due to the three-dimensional network structure of the nanostructure, which is the dispersoid.

Specifically, it means a dispersion having a shear modulus of 102 to 10⁶ Pa. The dispersion medium of the gel is an aqueous system such as water (H₂O), or an organic system such as carboxylic acids, methanol (CH₃OH), ethanol (C₂H₅OH), propanol (C₃H₇OH), n-butanol, isobutanol, n-butylamine, dodecane, unsaturated fatty acids, ethylene glycol, heptane, hexadecane, isoamyl alcohol, octanol, isopropanol, acetone, or glycerin, and two or more kinds thereof may be mixed.

The gel produced by the bacteria has a basic structure of nanofibers on the nm order, and by using this gel to produce carbon materials, the resulting carbon materials have a high specific surface area. Specifically, by using the gel produced by bacteria, it is possible to synthesize hard carbon with a specific surface area of 300 m²/g or more.

The bacteria-produced gel has a structure in which the nanofibers are entangled in a coil or mesh shape, and furthermore, the nanofibers have a branched structure on the basis of the proliferation of the bacteria. As a result, the hard carbon produced achieves excellent stretchability, with a strain of 50% or more at the elastic limit.

The bacteria may be any known bacteria, for example, those produced by culturing acetic acid bacteria such as Acetobacter xylinum subsp. sucrofermentans, Acetobacter xylinum ATCC23768, Acetobacter xylinum ATCC23769, Acetobacter pasteurianus ATCC10245, Acetobacter xylinum ATCC14851, Acetobacter xylinum ATCC11142, and Acetobacter xylinum ATCC10821. The bacteria may also be produced by culturing various mutant strains created by subjecting these acetic acid bacteria to a mutation treatment with a known method using nitrosoguanidine (NTG), etc.

In the freezing step, the bacteria-produced gel is frozen to obtain a frozen body (step S12). The freezing step is carried out, for example, by storing the bacteria-produced gel in a suitable container, such as a test tube, and cooling the surroundings of the test tube in a coolant, such as liquid nitrogen, to freeze the bacteria-produced gel stored in the test tube. The freezing method is not particularly limited as long as the dispersion medium of the gel can be cooled to a temperature equal to or lower than the freezing point. The dispersion medium may be cooled in a freezer or the like.

By freezing the bacteria-produced gel, the dispersion medium loses its fluidity, the cellulose nanofibers, which are dispersoids, are fixed, and a three-dimensional network structure is formed.

In the drying step, the frozen body is dried in a vacuum to obtain a dried body (bacteria-produced xerogel) (step S13). In the drying step, the frozen body obtained in the freezing step is dried in a vacuum, and the frozen dispersion medium is sublimated from a solid state. For example, the obtained frozen body is stored in an appropriate container, such as a flask, and the inside of the container is evacuated to a vacuum. By disposing the frozen body in a vacuum atmosphere, the sublimation point of the dispersion medium is lowered, and even a substance that is not sublimated at normal pressure can be sublimated.

The degree of vacuum in the drying step varies depending on the dispersion medium to be used, but is not particularly limited as long as it is a degree of vacuum at which the dispersion medium sublimates. For example, when water is used as the dispersion medium, it is necessary to set the degree of vacuum to a pressure of 0.06 MPa or less, but since heat is removed as latent heat of sublimation, it takes t for drying. Therefore, the degree of vacuum is preferably 1.0×10⁻⁶ to 1.0×10⁻² Pa. Furthermore, heat may be applied using a heater or the like during drying.

In the carbonization step, the dried body (bacteria-produced xerogel) is heated and carbonized in a non-combustible atmosphere to obtain amorphous carbon derived from bacteria-produced cellulose (step S14).

In the following description, “amorphous carbon derived from bacteria-produced cellulose” may also be referred to as “amorphous carbon”.

The carbonization of the bacteria-produced xerogel may be performed by calcining at 500 °C to 2000 °C, and more preferably 900 °C to 1800 °C in an inert gas atmosphere. A gas that does not burn cellulose may be, for example, an inert gas such as nitrogen gas or argon gas. The gas that does not burn cellulose may be a reducing gas such as hydrogen gas or carbon monoxide gas, or may be carbon dioxide gas. In the present embodiment, from the viewpoint of cost, inexpensive nitrogen gas is more preferable.

In the crystal growth step, the amorphous carbon derived from bacteria-produced cellulose carbonized in the carbonization step is heated again in a non-combustible atmosphere while applying pressure, to obtain hard carbon derived from bacteria-produced cellulose (step S15).

The hard carbon of the present embodiment has a three-dimensional network structure in which the nanofibers of the bacteria-produced gel are branched and connected cocontinuously, and a hexagonal plate-like layered crystal structure of carbon into which ions are insertable and removable.

Generally, amorphous carbon does not have a layered structure of connected six-membered carbon rings like graphite, and therefore ions cannot be inserted or removed between the layers of the six-membered carbon rings, and thus cannot be used as a negative electrode active material. Therefore, in the present embodiment, heat treatment is performed at 1200 °C to 3000 °C to promote the crystal growth of graphite and obtain hard carbon suitable for the negative electrode active material of ion batteries.

Amorphous carbon derived from bacteria-produced cellulose has a three-dimensional network structure with fiber diameters of several tens of nanometers, and because the fibrous amorphous carbon is in a coarse state, there is a limit to the crystal growth of graphite even when heat treatment is performed at high temperatures.

Therefore, in the present embodiment, the amorphous carbon is subjected to a heat treatment while pressure is applied, so that the fibrous amorphous carbons are brought into contact with each other, and the crystal growth of graphite is promoted. Therefore, the fiber diameter of the hard carbon after the crystal growth step is greater than the fiber diameter of the amorphous carbon before the crystal growth step, but the three-dimensional network structure is still maintained in the hard carbon after the crystal growth step. Accordingly, in the present embodiment, it is possible to produce hard carbon having a large active material surface area and a high diffusion rate of ions received on the surface of the active material. Therefore, the hard carbon of the present embodiment is suitable as a negative electrode active material for an ion battery.

In addition, since the hard carbon of the present embodiment has a three-dimensional network structure, the active materials are continuous with each other, and have a very high conductive path. Furthermore, joint portions between the carbon fibers of hard carbon are branched and act as springs, giving a stretchability. In other words, the three-dimensional network structure of the present embodiment is formed by the joint portions between the cellulose nanofibers branching and entangling to be connected cocontinuously, which gives the hard carbon of the present embodiment elasticity and a restoring force. Therefore, it is also possible to withstand the expansion and contraction that accompanies the insertion and removal of ions during charging and discharging, and the negative electrode active material does not crack and the conductive paths do not break.

Crystal growth of amorphous carbon derived from bacteria-produced cellulose may be achieved by carbonizing the material through heat treatment in an inert gas atmosphere at 1200 °C to 3500 °C, more preferably at 1500 °C to 3000 °C. A gas that does not burn amorphous carbon may be, for example, an inert gas such as nitrogen gas or argon gas. The gas that does not burn amorphous carbon may be a reducing gas such as hydrogen gas. From the viewpoint of cost, inexpensive nitrogen gas is more preferable, but typically, a more inert argon gas is used in equipment that performs heat treatment at such high temperatures.

The pressure applied during the heat treatment varies greatly depending amount of amorphous carbon, particularly the thickness in the direction in which the pressure is applied. Specifically, the pressure may be adjusted so that the thickness of the amorphous carbon in the direction in which the pressure is applied is ½ to 1/100, more preferably 1/10 to 1/50.

This is because if the pressure is too low, the crystals cannot grow and the material cannot function as a negative electrode active material, whereas if the pressure is too high, the three-dimensional network structure is crushed by sintering during the heat treatment.

The method of applying pressure is not particularly limited, but pressure can be easily applied by placing a weight made of ceramic, graphite, or the like on the amorphous carbon. Graphite is preferred since it has the same composition as the hard carbon, which is an object to be produced in the present disclosure. Therefore, in the crystal growth step, it is desirable to place graphite on the amorphous carbon and apply pressure to the amorphous carbon.

In addition, pressure may be applied to the amorphous carbon during the crystal growth step using the aforementioned screw-type sealed crucible. That is, a screw-type sealed crucible can be used, and pressure can be applied by pushing in the lid until the thickness of the amorphous carbon becomes ½ to 1/100, more preferably 1/10 to 1/50.

In general, in graphitizing carbon materials and organic substances, pressure is applied to the carbon materials and organic substances before heat treatment for crystal growth, and then heat treatment is performed. However, because amorphous carbon derived from bacteria-produced cellulose has stretchability, even if pressure is applied temporarily, it will return to its original shape once the pressure application is stopped, and the effect of applying pressure before heat treatment will not last.

Even if pressure is applied during heat treatment when graphitizing general carbon materials and organic substances, a small pressure such as that applied by placing a weight made of ceramic or graphite on the material is ineffective. Therefore, it is necessary to apply a large amount of pressure using a press or a jig, but it is difficult to obtain a press or a jig that can withstand high temperatures of 1200 °C to 3500 °C, and there is currently no way to do this.

Even if a screw-type sealed crucible is used, screw-type sealed crucibles that can withstand high temperatures of 1200 °C to 3500 °C are made of graphite, and if a graphite screw-type sealed crucible is exposed to high temperatures while a large pressure is applied, it will expand and crack or the like. Therefore, screw-type sealed crucibles are not usually used for the purpose of applying pressure.

On the other hand, amorphous carbon derived from bacteria-produced cellulose has stretchability as mentioned above, and contracts sufficiently even with a weight made of ceramic or graphite, so that even a small pressure of 10 N/cm² is effective in promoting crystal growth. The applied pressure is preferably 10 to 100 kN/cm².

Furthermore, as described above, since the effect is sufficient even with a small pressure, even if a screw-type sealed crucible is used and the amorphous carbon derived from bacteria-produced cellulose is exposed to high temperatures while pressure is being applied, the screw-type sealed crucible will not be damaged.

According to the above-mentioned method for producing hard carbon derived from bacteria-produced cellulose, the cellulose nanofibers, which are dispersoids, are fixed by the freezing step, and a three-dimensional network structure is constructed.

Furthermore, the drying step allows the extraction of cellulose nanofibers while maintaining their three-dimensional network structure. Therefore, a sufficient specific surface area can be obtained, and a continuous, stretchable negative electrode active material can be produced. Furthermore, in the crystal growth step, a hexagonal plate-like layered crystal structure of carbon into which ions are insertable and removable, can be formed.

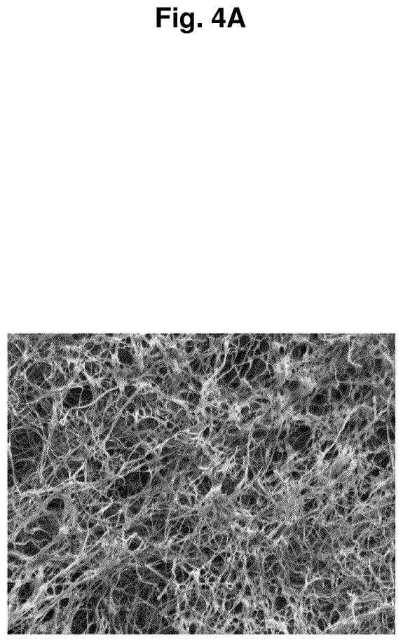

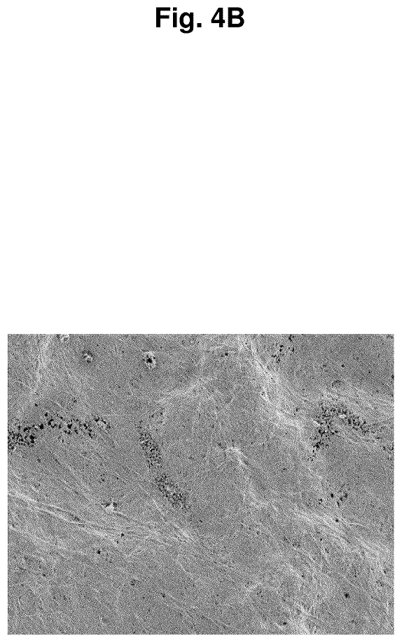

FIGS. 4A and 4B are SEM images of hard carbon derived from bacteria-produced cellulose. The magnification is 10,000 times.

FIG. 4A is an SEM image of hard carbon derived from bacteria-produced cellulose produced using the production method of the present embodiment. From the image, it can be seen that the cellulose nanofibers are fixed and a three-dimensional network structure is constructed.

FIG. 4B shows the state of hard carbon derived from bacteria-produced cellulose in a case where the cellulose nanofibers are dried and carbonized in the atmosphere, which is different from the production method of the present embodiment. As the frozen body changes from solid to liquid and then from liquid to gas, the three-dimensional network structure of the cellulose nanofibers is destroyed. As shown in FIG. 4B, if the three-dimensional network structure is destroyed, it becomes difficult to produce hard carbon with a high specific surface area.

As described above, the hard carbon derived from bacteria-produced cellulose produced using the production method of the present embodiment is hard carbon having the three-dimensional network structure and having stretchability. Furthermore, the hard carbon derived from bacteria-produced cellulose of the present embodiment has high electrical conductivity, corrosion resistance, and a high specific surface area.

Therefore, the hard carbon derived from bacteria-produced cellulose produced using the production method of the present embodiment is suitable not only as a negative electrode material for ion batteries, but also as batteries, capacitors, fuel cells, biofuel cells, microbial batteries, catalysts, solar cells, semiconductor manufacturing processes, medical equipment, beauty tools, filters, heat-resistant materials, flame-resistant materials, heat insulating materials, conductive materials, electromagnetic wave shielding materials, electromagnetic noise absorbing materials, heating elements, microwave heating elements, corn paper, clothing, carpets, anti-fogging mirrors, sensors, touch panels, etc.

### [Ion Battery]

Hereinafter, an ion battery using the hard carbon derived from cellulose nanofibers or the hard carbon derived from bacteria-produced cellulose of the present embodiment will be described.

An ion battery usually has an electrolyte (a non-aqueous electrolytic solution, a solid electrolyte, or the like), a negative electrode, and a positive electrode as its main battery components, and these elements are enclosed in, for example, a battery housing. The negative electrode and the positive electrode function through insertion and removal of ions, respectively. In the battery mechanism of an ion battery, ions are inserted into the negative electrode during charging, and ions are removed from the negative electrode during discharging. For the negative electrode, generally, a current collector made of copper foil and a negative electrode material (negative electrode active material) bound with a binder are used.

The ion battery described here uses the hard carbon derived from cellulose nanofibers or the hard carbon derived from bacteria-produced cellulose according to the above embodiment as the negative electrode active material, but the other materials are not particularly limited. Other battery components, such as an electrolytic solution, a positive electrode, and a separator, are similar to those of general secondary batteries.

Each component of the ion battery will be described below.

### (1) Positive Electrode

The positive electrode contains at least a positive electrode active material, and can contain additives such as a conductive auxiliary agent and a binder as necessary. The positive electrode may be formed into a current collector, such as a foil, mesh, expanded metal, foamed metal, or the like.

### (1-1) Positive Electrode Active Material

A compound is used for the positive electrode active material of the present embodiment, and it is preferable to select one that enables insertion and removal of a sufficient number of ions. For example, in the case of a lithium ion battery, it is a lithium compound, and in the case of a sodium ion battery, it is a sodium compound.

Specifically, transition metal oxides, transition metal chalcogenides, vanadium oxides, organic substances, and the like can be used.

The following describes the case of a lithium ion battery as an example, but the present disclosure is not limited to lithium, and a lithium ion battery can be replaced with any known ion battery. For example, in the case of a sodium ion battery, lithium may be replaced with sodium, and in the case of a magnesium ion battery, lithium may be replaced with magnesium.

In the case of a lithium ion battery, the transition metal composite oxide is a lithium-containing transition metal composite oxide, which is a composite oxide of lithium and a transition metal. Also, it may be a solid solution of lithium and two or more transition metals, and the composite oxide may be used alone or in combination of two or more kinds. Specifically, the lithium-containing transition metal composite oxide is represented by LiM1_{(1-X-Y)}M2_{X}M3_{Y}O₂ (wherein X and Y are numbers in the range of 0≤X+Y≤1, and M1, M2, and M3 are at least one transition metal element) or LiM1_{(1-Z-α)}M2_{Z}M3_{α}PO₄ (wherein Y is a number in the range of 0≤Z+α≤1, and M1, M2, and M3 are at least one transition metal element).

The transition metal elements represented by M1, M2, and M3 are Co, Ni, Mn, Cr, Ti, V, Fe, Zn, Al, In, Sn, and the like, and Co, Ni, Mn, Cr, Ti, V, Fe, Al, and the like are preferable. Preferred specific examples are LiCoO₂, LiNiO₂, LiMnO₂, LiNiO_{0.9}Co_{0.1}O₂, LiNi_{0.5}Co_{0.5}O₂, LiNi_{0.3}Mn_{0.3}Co_{0.4}O₂, LiFePO₄, and the like.

These can be obtained, for example, as a commercially available product or by a known synthesis.

For example, a lithium-containing transition metal oxide can be obtained by using lithium, transition metal oxides, hydroxides, salts, etc. as starting materials, mixing these starting raw materials according to the desired metal oxide composition, and calcining the mixture at a temperature of 600 °C to 1000 °C.

The positive electrode active material may use the lithium compounds alone or in combination of two or more kinds.

### (1-2) Conductive Auxiliary Agent

In the present embodiment, the positive electrode may contain a conductive auxiliary agent. As the conductive auxiliary agent, for example, carbon can be used. Specific examples of the conductive auxiliary agent include carbon black such as Ketjen black and acetylene black, activated carbon, graphite, and carbon fibers. In order to sufficiently ensure a reaction site in the positive electrode, carbon having a small particle size is suitable. Specifically, carbon having a particle size of 1 μm or less is desirable. These carbons can be obtained, for example, as a commercially available product or by a known synthesis.

The positive electrode active material may be directly coated with carbon. Examples of the coating method include physical methods such as vapor deposition, sputtering, and a planetary ball mill, chemical methods, such as coating with an organic substance followed by heat treatment, and known methods.

### (1-3) Binder

In the present embodiment, the positive electrode may contain a binder. The binder is not particularly limited, but it is preferable to use a binder that has chemical stability and electrochemical stability with respect to the electrolyte. For example, fluorine-based resins such as polyvinylidene fluoride and polytetrafluoroethylene, polyethylene, polyvinyl alcohol, styrene-butadiene rubber, and further carboxymethyl cellulose are used. Two or more of these may be used in combination.

To produce the positive electrode, N-methylpyrrolidone, dimethylformamide, water, alcohol, and the like, which are common solvents for producing positive electrodes, can be used.

Regarding the contents of the above-mentioned positive electrode active material, the conductive auxiliary agent, and the binder in the case of using the positive electrode active material in a powder form, the content of the positive electrode active material is more than 0% by weight and 99% or less and preferably 70 to 95% by weight, the content of the conductive auxiliary agent is 0 to 90% by weight and preferably 1 to 30% by weight, and the content of the binder is 0 to 50% by weight and preferably 1 to 30% by weight, based on the weight of the entire positive electrode.

### (1-4) Preparation of Positive Electrode

The positive electrode can be prepared as follows.

The positive electrode is produced, for example, by dispersing a positive electrode mixture in a solvent to prepare a paste-like positive electrode mixture, and then applying the positive electrode mixture to one or both sides of a current collector and drying it. This results in a positive electrode in which a positive electrode mixture layer (active material layer) is uniformly and firmly adhered to the current collector.

More specifically, for example, the LiCoO₂, a dispersant for fluorine-based resin powder, and a solvent are mixed to form a slurry, and then the slurry is stirred and mixed using a known stirrer, mixer, kneading machine, kneader, or the like to prepare a positive electrode mixture paste. When this positive electrode mixture paste is applied to a current collector and dried, the positive electrode mixture layer is uniformly and firmly adhered to the current collector. The film thickness of the positive electrode mixture layer is 10 to 200 μm, preferably 30 to 100 μm.

The positive electrode mixture layer can also be produced by dry-mixing the active material with a powder of a resin such as polyethylene or polyvinyl alcohol, and hot-pressing the mixture in a mold. However, in the dry mixing, a large amount of binder is required to obtain sufficient strength of the positive electrode, and in a case where the binder is used in excess, the discharge capacity and the rapid charge/discharge efficiency may decrease.

After the positive electrode mixture layer is formed, the adhesive strength between the positive electrode mixture layer and the current collector can be further increased by performing pressure bonding such as pressing.

The shape of the current collector used in the positive electrode is not particularly limited, but a foil, mesh, expanded metal, foamed metal, or the like is preferred. The material of the current collector is preferably aluminum, iron, titanium, stainless steel, nickel, carbon, conductive resin, copper, or the like. In a case where the current collector is in the form of a foil, its thickness is preferably 5 to 20 μm.

### (2) Negative Electrode

The negative electrode of the present embodiment contains at least the above-mentioned hard carbon derived from cellulose nanofibers or hard carbon derived from bacteria-produced cellulose, and can contain additives such as a conductive auxiliary agent and a binder as necessary. The negative electrode may be formed into a current collector such as a foil, mesh, expanded metal, foamed metal, or the like.

### (2-1) Negative Electrode Active Material

In the present embodiment, hard carbon derived from cellulose nanofibers or hard carbon derived from bacteria-produced cellulose is used as the negative electrode active material. The average particle size of the hard carbon derived from cellulose nanofibers and the hard carbon derived from bacteria-produced cellulose is preferably 1 μm to 1 mm, and more preferably 10 to 500 μm.

In addition to the above, known materials can be used as the negative electrode active material of the ion battery. Representative examples of known materials include: natural graphite, artificial graphite obtained by graphitizing cokes, artificial graphite obtained by pulverizing, oxidizing, carbonizing and graphitizing bulk mesophase pitch, graphitized spherical mesocarbon microspheres, and graphitized pulverized mesocarbon microspheres.

The negative electrode active material may be a mixture or composite of the hard carbon of the present embodiment and any one of different graphite materials, carbonaceous or graphitic fibers, carbon materials such as amorphous hard carbon, organic materials, inorganic materials, and metal materials. Specifically, the hard carbon of the present embodiment may be one to which an organic compound, such as a surfactant or a polymer, is attached or coated, one to which fine particles of a metal oxide, such as silica, alumina, or titania, are attached or embedded, or one to which a metal or a metal compound, such as silicon, tin, cobalt, nickel, copper, silicon oxide, or tin oxide, is attached, embedded, compounded, or encapsulated.

The average particle size of the negative electrode active material made of a known material is preferably smaller than the average particle size of the hard carbon derived from cellulose nanofibers and the hard carbon derived from bacteria-produced cellulose of the present embodiment. For example, the average particle size of the known material is preferably 0.1 to 30 μm, and more preferably 0.1 to 10 μm.

By making the average particle size of the negative electrode active material, which is a known material, smaller than the average particle size of the hard carbon of the present embodiment, a high-density negative electrode can be prepared. However, high-density negative electrodes usually suffer from problems such as reduced electrolytic solution permeability and retention, and increased expansion during charging.

On the other hand, the hard carbon of the present embodiment has a large number of voids, which allows a plurality of negative electrode active materials to come into uniform contact with the electrolytic solution, and further allows high electrical conductivity to be exhibited. In the present embodiment, a negative electrode active material containing hard carbon derived from cellulose nanofibers or hard carbon derived from bacteria-produced cellulose, with a three-dimensional network structure, is used, and therefore, even in a high-density negative electrode, problems such as reduced electrolytic solution permeability and retention, and increased expansion during charging do not occur.

### (2-2) Conductive Auxiliary Agent

In a case of using the negative electrode active material in a powder form, the negative electrode may contain a conductive auxiliary agent. As the conductive auxiliary agent, for example, carbon can be used. Specific examples of the conductive auxiliary agent include carbon black such as Ketjen black and acetylene black, activated carbon, graphite, and carbon fibers. In order to sufficiently ensure a reaction site in the negative electrode, carbon having a small particle size is suitable. Specifically, carbon having a particle size of 1 μm or less is desirable. These carbons can be obtained, for example, as a commercially available product or by a known synthesis.

The negative electrode active material may be directly coated with carbon. Examples of the coating method include physical methods such as vapor deposition, sputtering, and a planetary ball mill, chemical methods such as coating with an organic substance followed by heat treatment, and known methods.

### (2-3) Binder

The negative electrode may contain a binder. The binder is not particularly limited, but it is preferable to use a binder that has chemical stability and electrochemical stability with respect to the electrolyte. Examples of the binder that can be used include fluorine-based resins such as polyvinylidene fluoride and polytetrafluoroethylene, polyethylene, polyvinyl alcohol, styrene-butadiene rubber, and further carboxymethyl cellulose. Two or more of these can also be used in combination.

To produce the negative electrode, N-methylpyrrolidone, dimethylformamide, water, alcohol, and the like, which are common solvents for producing negative electrodes, can be used.

Regarding the contents of the negative electrode active material, the conductive auxiliary agent, and the binder in the case of using the negative electrode active material in a powder form, the content of the negative electrode active material is more than 0% by weight and 99% or less and preferably 70 to 95% by weight, the content of the conductive auxiliary agent is 0 to 90% by weight and preferably 1 to 30% by weight, and the content of the binder is 0 to 50% by weight and preferably 1 to 30% by weight based on the weight of the entire negative electrode.

### (2-4) Preparation of Negative Electrode

The negative electrode can be prepared as follows.

The negative electrode is produced, for example, by dispersing a negative electrode mixture in a solvent to prepare a paste-like negative electrode mixture, and then applying the negative electrode mixture to one or both sides of a current collector and drying it. This results in a negative electrode in which a negative electrode mixture layer (active material layer) is uniformly and firmly adhered to the current collector.

More specifically, for example, the hard carbon derived from cellulose nanofibers or the hard carbon derived from bacteria-produced cellulose, Ketjen black, a water dispersant (binder) for fluorine-based resin powder or styrene-butadiene rubber, and a solvent are mixed to form a slurry. This slurry is then stirred and mixed using a known stirrer, mixer, kneading machine, kneader, or the like to prepare a negative electrode mixture paste. When this positive electrode mixture paste is applied to a current collector and dried, the negative electrode mixture layer is uniformly and firmly adhered to the current collector. The film thickness of the negative electrode mixture layer is 10 to 200 μm, preferably 30 to 100 μm.

The negative electrode mixture layer can also be produced by dry mixing the hard carbon derived from cellulose nanofibers or hard carbon derived from bacteria-produced cellulose with a resin powder (binder) such as polyethylene or polyvinyl alcohol, and hot press molding the mixture in a mold. However, in the dry mixing, a large amount of binder is required to obtain sufficient strength of the negative electrode, and in a case where the binder is used in excess, the discharge capacity and the rapid charge/discharge efficiency may decrease.

After the negative electrode mixture layer is formed, the adhesive strength between the negative electrode mixture layer and the current collector can be further increased by performing pressure bonding such as pressing.

The shape of the current collector used in the negative electrode is not particularly limited, but a foil, mesh, expanded metal, foamed metal, or the like is preferred. The material of the current collector is preferably copper, iron, titanium, stainless steel, nickel, carbon, conductive resin, aluminum, or the like. In a case where the current collector is in the form of a foil, its thickness is preferably 5 to 20 μm.

### (3) Electrolyte

The ion battery of the present embodiment includes an electrolyte. The electrolyte is not particularly limited as long as it allows the movement of ions (Li⁺, Na⁺, K⁺, Mg²⁺, Ca²⁺, Al³⁺). As the electrolyte, an aqueous electrolytic solution, a non-aqueous electrolytic solution, a solid electrolyte, a polymer solid electrolyte, or the like may be used.

Specifically, as electrolyte salts that can be used in the non-aqueous electrolytic solution of a typical lithium ion battery, for example, lithium salts such as LiPF₆, LiBF₄, LiAsF₆, LiClO₄, LiB(C₆H₅)₄, LiCl, LiBr, LiCF₃SO₃, LiCH₃SO₃, LiN(CF₃SO₂)₂, LiC(CF₃SO₂)₃, LiN(CF₃CH₂OSO₂)₂, LiN(CF₃CF₂OSO₂)₂, LiN(HCF₂CF₂CH₂OSO₂)₂, LiN[(CF₃)₂CHOSO₂]₂, LiB[C₆H₃(CF₃)₂]₄, LiAlCl₄, or LiSiF₅ can be used. In particular, LiPF₆, LiBF₄, LiN(CF₃SO₂)₂ are preferred from the standpoint of redox stability.

The electrolyte salt concentration of the electrolytic solution is preferably 0.1 to 5 mol/L, and more preferably 0.5 to 3 mol/L.

The electrolyte may be in any form such as liquid, cream, gel, and solid.

Examples of the solvent constituting the non-aqueous electrolytic solution include carbonates such as ethylene carbonate, propylene carbonate, dimethyl carbonate, and diethyl carbonate; ethers such as 1,1- or 1,2-dimethoxyethane, 1,2-diethoxyethane, tetrahydrofuran, 2-methyltetrahydrofuran, γ-butyrolactone, 1,3-dioxolane, 4-methyl-1,3-dioxolane, anisole, and diethyl ether; thioethers such as sulfolane and methylsulfolane; nitriles such as acetonitrile, chloronitrile, and propionitrile; and aprotic organic solvents such as trimethyl borate, tetramethyl silicate, nitromethane, dimethylformamide, N-methylpyrrolidone, ethyl acetate, trimethyl orthoformate, nitrobenzene, benzoyl chloride, benzoyl bromide, tetrahydrothiophene, dimethyl sulfoxide, 3-methyl-2-oxazolidone, ethylene glycol, and dimethyl sulfite.

In a case where a polymer solid electrolyte is used, it is preferable to use a polymer compound gelled with a plasticizer (non-aqueous electrolytic solution) as the matrix. As the polymer compound constituting the matrix, ether-based polymer compounds such as polyethylene oxide and its crosslinked products, polymethacrylate-based polymer compounds, polyacrylate-based polymer compounds, fluorine-based polymer compounds such as polyvinylidene fluoride and vinylidene fluoride-hexafluoropropylene copolymers, etc., can be used alone or in combination. It is particularly preferable to use a fluorine-based polymer compound such as polyvinylidene fluoride or a vinylidene fluoride-hexafluoropropylene copolymer.

A plasticizer is blended into the polymer solid electrolyte or polymer gel electrolyte, and the above-mentioned electrolyte salt or non-aqueous solvent can be used as the plasticizer. In the case of a polymer gel electrolyte, the electrolyte salt concentration of the non-aqueous electrolytic solution, which is a plasticizer, is preferably 0.1 to 5 mol/L, and more preferably 0.5 to 2 mol/L.

The method for producing the polymer solid electrolyte is not particularly limited, and examples thereof include a method of mixing a polymer compound, a lithium salt, and a non-aqueous solvent (plasticizer) constituting a matrix, and heating to melt the polymer compound; a method of dissolving a polymer compound, a lithium salt, and a non-aqueous solvent (plasticizer) in an organic solvent for mixing, and then evaporating the organic solvent for mixing; and a method of mixing a polymerizable monomer, a lithium salt, and a non-aqueous solvent (plasticizer), and irradiating the mixture with ultraviolet rays, an electron beam, a molecular beam, or the like to polymerize the polymerizable monomer to obtain a polymer compound.

The proportion of the non-aqueous solvent (plasticizer) in the polymer solid electrolyte is preferably 10 to 90% by mass, and more preferably 30 to 80% by mass. If it is less than 10% by mass, the electrical conductivity will be low, and if it exceeds 90% by mass, the mechanical strength will be weakened, making it difficult to form a film.

### (4) Other Elements

In addition to the aforementioned constituent elements, the ion battery of the present embodiment may include a structural member such as a separator and a battery case and also other elements required for an ion battery. As these, conventionally known ones can be used.

### (5) Method for Manufacturing Ion Battery

As described above, the ion battery of the present embodiment includes at least a positive electrode, a negative electrode, and an electrolytic solution, and the electrolytic solution is disposed between the positive electrode and the negative electrode so as to be in contact with the positive electrode and the negative electrode. The ion battery having such a configuration is prepared in a manner similar to a conventional ion battery.

For example, a lithium ion battery can be produced by assembling the various elements according to the related art: a positive electrode active material containing LiCoO₂ as described above, a positive electrode containing a conductive auxiliary agent and a binder, a negative electrode containing hard carbon derived from cellulose nanofibers or hard carbon derived from bacteria-produced cellulose, and a non-aqueous electrolytic solution disposed in contact with the positive electrode and the negative electrode.

### (5-1) Method for Manufacturing Coin-Type Ion Battery

As an embodiment of the method for manufacturing an ion battery, for example, a coin-type ion battery can be manufactured.

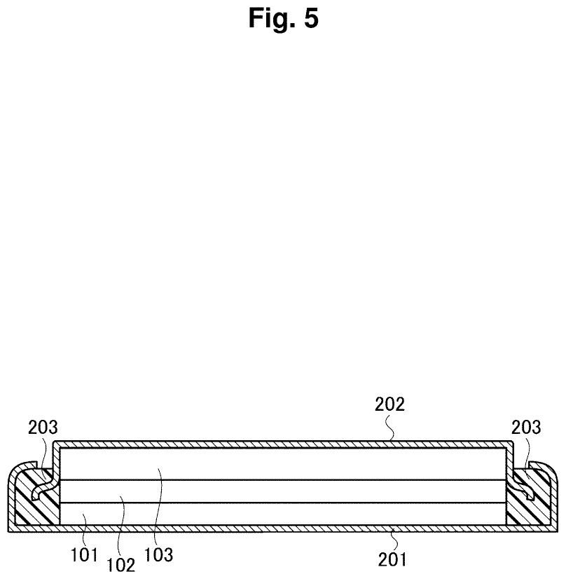

FIG. 5 is a schematic cross-sectional view illustrating a structure of a coin-type lithium battery. Specifically, first, a separator (not illustrated) is placed on a positive electrode case 201 where the positive electrode 101 is placed, and an electrolytic solution 102 is injected into the placed separator. Next, the negative electrode 103 is placed on the electrolytic solution 102, and the positive electrode case 201 is covered with a negative electrode case 202. Next, peripheral portions of the positive electrode case 201 and the negative electrode case 202 are crimped with a coin cell crimping machine, thereby producing a coin-type ion battery including a propylene gasket 203.

In order to confirm the effects of the production methods of the first embodiment and the second embodiment described above, an experiment was conducted to compare a negative electrode containing hard carbon (Examples 1-4) produced using the production methods of the first embodiment and the second embodiment with a negative electrode containing a carbon material (Comparative Examples 1-5) produced using a production method different from the embodiments.

### EXAMPLES

Examples of the negative electrode according to the present embodiment will be described in detail below. In each example, an electrode using hard carbon derived from cellulose nanofibers and an electrode using hard carbon derived from bacteria-produced cellulose are used as working electrodes. As a counter electrode, an electrode using lithium (Li), sodium (Na), potassium (K), magnesium (Mg), calcium (Ca), and aluminum (Al) is used. In the examples, a plurality of ion batteries were produced by combining the electrode of the working electrode and the electrode of the counter electrode.

Note that the present disclosure is not limited to those described in the following examples, and can be appropriately modified and implemented without changing the gist of the present disclosure.

### Example 1

In Example 1, the above-mentioned coin-type battery (FIG. 5) was produced through the following procedure. As counter electrodes, a lithium (Li) foil, a sodium (Na) foil, a potassium (K) foil, a magnesium (Mg) foil, a calcium (Ca) foil, and an aluminum (Al) foil were used. The non-aqueous electrolytic solution used was a triethylene glycol dimethyl ether (TEGDME) solvent containing 1.0 mol/L of bis(trifluoromethanesulfonyl)imide salt corresponding to each counter electrode. Specifically, in a case where lithium (Li) was used as the counter electrode, lithium bis(trifluoromethanesulfonyl)imide was used.

### (Production of Hard Carbon)

Cellulose nanofibers (manufactured by NIPPON PAPER INDUSTRIES CO., LTD.) were used, and 1 g of cellulose nanofibers and 10 g of ultrapure water were stirred for 12 hours using a homogenizer (manufactured by SMT) to prepare a cellulose nanofiber dispersion, which was then poured into a test tube.

The test tube was immersed in liquid nitrogen for 30 minutes to completely freeze the cellulose nanofiber dispersion. After the cellulose nanofiber dispersion was completely frozen, the frozen cellulose nanofiber dispersion was placed on a petri dish and dried in a vacuum of 10 Pa or less using a freeze dryer (manufactured by TOKYO RIKAKIKAI CO., LTD.) to obtain a dried body of cellulose nanofibers. The dried body was dried in a vacuum, and then heat-treated at 600 °C for 2 hours in a nitrogen atmosphere to carbonize the cellulose nanofibers, obtaining amorphous carbon derived from the cellulose nanofibers.

Next, a graphite plate of such weight that the thickness of the amorphous carbon was 1/10 was placed on the amorphous carbon, and the carbon was heat-treated in a graphitization furnace (manufactured by KURATA GIKEN.) at 2500 °C for 30 minutes in an argon gas atmosphere to promote crystal growth of carbon derived from cellulose nanofibers and produce hard carbon derived from cellulose nanofibers. In this way, the hard carbon of Example 1 was produced.

### (Preparation of Working Electrode)

The hard carbon, a Ketjen black powder (EC600JD, Lion Specialty Chemicals Co., Ltd.), and a polytetrafluoroethylene (PTFE) powder were sufficiently pulverized and mixed at the weight ratio of 80:10:10 using a pounding machine, and roll-formed to produce a sheet-like electrode (having the thickness of 0.5 mm). The sheet-like electrode was cut into a circle having a diameter of 16 mm and pressed on a copper mesh to obtain a working electrode.

### (Preparation of Counter Electrode)

Counter electrodes were obtained by cutting out circles with a diameter of 16 mm from 150 μm-thick lithium (Li), sodium (Na), potassium (K), magnesium (Mg), calcium (Ca), and aluminum (Al) foils.

### (Preparation of Battery)

A coin-type battery illustrated in FIG. 5 was produced using coin battery cases (Hohsen Corp.). A cellulose-based separator (NIPPON KODOSHI CORPORATION.) cut to a diameter of 18 mm was placed on the positive electrode case 201 in which the hard carbon 101 prepared by the above method was placed. A non-aqueous electrolytic solution 102 obtained by dissolving 1.0 mol/L of bis(trifluoromethanesulfonyl)imide salt corresponding to each counter electrode in a triethylene glycol dimethyl ether (TEGDME) solvent was poured into the placed separator. The counter electrode 103 was placed on the non-aqueous electrolytic solution 102, the positive electrode case 201 was covered with the negative electrode case 202, and peripheral portions of the positive electrode case 201 and the negative electrode case 202 were crimped with a coin cell crimping machine, thereby obtaining a coin-type battery including the propylene gasket 203.

In Example 1, six types of ion batteries were produced using hard carbon derived from cellulose nanofibers as the working electrode, and lithium (Li), sodium (Na), potassium (K), magnesium (Mg), calcium (Ca), and aluminum (Al) as the counter electrode.

### (Battery Performance)

The battery performance of the battery prepared with the above procedure was measured. In the charge/discharge test and cycle test of the battery, measurement was performed using a charge and discharge measurement system (manufactured by Bio Logic). A current density of 1 mA/cm² per effective area of the electrode containing hard carbon was applied, and the discharge voltage was measured until the battery voltage dropped from the open circuit voltage to 0.0 V. Then, a current was applied at the same current value, and the charge voltage was measured until it rose to 2.7 V. This charge/discharge test was repeated to carry out a cycle test. In addition, to evaluate the current characteristics, a charge/discharge test was also carried out in which a current was applied through the electrode containing hard carbon at a current density of 50 mA/cm² per effective area. The charge/discharge test of the battery was performed under a normal living environment. The charge/discharge capacity was expressed as the value per unit weight of hard carbon (mAh/g). The charge/discharge test was performed using a sample different from that used in the cycle test.

Table 1 below shows the discharge capacity at the second cycle when a current of 1 mA/cm² is applied to batteries using lithium (Li), sodium (Na), potassium (K), magnesium (Mg), calcium (Ca), and aluminum (Al) as the counter electrode, as well as the discharge capacities after 10, 50, and 100 cycles, and the discharge capacities after two cycles when a current of 50 mA/cm² is applied.

Thus, it was found that the hard carbon derived from cellulose nanofibers of Example 1 has excellent performance as a negative electrode material for ion batteries.

TABLE 1

| | | | | | | | | | | Large | |
|---|---|---|---|---|---|---|---|---|---|---|---|
| | | | | | | | | | | current | |
| | | | | | | | | | | test | |
| | | | | | | | | | | Current | |
| | | | | | | | | | | density: | |
| | Counter | Cycle test Current density: 1 mA/cm² | | | | | | | | 50 mA/cm² | |
| Example | electrode | 2 cycles | | 10 cycles | | 50 cycles | | 100 cycles | | 2 cycles | |
| Example 1 | Li | 403 | mAh/g | 395 | mAh/g | 381 | mAh/g | 363 | mAh/g | 288 | mAh/g |
| | Na | 354 | mAh/g | 347 | mAh/g | 340 | mAh/g | 329 | mAh/g | 256 | mAh/g |
| | K | 320 | mAh/g | 315 | mAh/g | 301 | mAh/g | 289 | mAh/g | 220 | mAh/g |
| | Mg | 155 | mAh/g | 155 | mAh/g | 150 | mAh/g | 148 | mAh/g | 120 | mAh/g |
| | Ca | 137 | mAh/g | 134 | mAh/g | 131 | mAh/g | 128 | mAh/g | 100 | mAh/g |
| | Al | 98 | mAh/g | 95 | mAh/g | 92 | mAh/g | 88 | mAh/g | 67 | mAh/g |
| Example 2 | Li | 425 | mAh/g | 421 | mAh/g | 409 | mAh/g | 383 | mAh/g | 309 | mAh/g |
| | Na | 413 | mAh/g | 410 | mAh/g | 389 | mAh/g | 375 | mAh/g | 290 | mAh/g |
| | K | 364 | mAh/g | 361 | mAh/g | 348 | mAh/g | 320 | mAh/g | 259 | mAh/g |
| | Mg | 155 | mAh/g | 152 | mAh/g | 149 | mAh/g | 142 | mAh/g | 110 | mAh/g |
| | Ca | 138 | mAh/g | 135 | mAh/g | 130 | mAh/g | 125 | mAh/g | 97 | mAh/g |
| | Al | 97 | mAh/g | 95 | mAh/g | 91 | mAh/g | 87 | mAh/g | 68 | mAh/g |

### Example 2

In Example 2, the cellulose nanofibers used in Example 1 were changed to bacteria-produced cellulose nanofibers to produce hard carbon derived from bacteria-produced cellulose. The battery was produced and evaluated in a manner similar to that in Example 1.

### (Production of Hard Carbon)

Bacterial cellulose gel (manufactured by Fujicco) produced by the acetic acid bacterium Acetobacter xylinum was used, and the bacteria-produced gel was completely frozen by immersing it in liquid nitrogen for 30 minutes in a polystyrene foam box. After completely freezing the bacteria-produced gel, the frozen bacteria-produced gel was taken out on a petri dish and dried in a vacuum of 10 Pa or less by a freeze dryer (manufactured by TOKYO RIKAKIKAI CO., LTD.) to obtain a bacteria-produced xerogel. After drying the bacteria-produced xerogel in a vacuum, the bacteria-produced xerogel was carbonized through heat treatment at 600 °C for 2 hours in a nitrogen atmosphere to obtain amorphous carbon derived from bacteria-produced cellulose. Next, a graphite plate of such weight that the thickness of the amorphous carbon was 1/10 was placed on the amorphous carbon, and the carbon was heat-treated in a graphitization furnace (manufactured by KURATA GIKEN.) at 2500 °C for 30 minutes in an argon gas atmosphere to promote crystal growth of carbon derived from bacteria-produced cellulose and produce hard carbon derived from bacteria-produced cellulose. In this way, the hard carbon of Example 2 was produced.

In Example 2, six types of ion batteries were produced using hard carbon derived from bacteria-produced cellulose as the working electrode, and lithium (Li), sodium (Na), potassium (K), magnesium (Mg), calcium (Ca), and aluminum (Al) as the counter electrode.

### (Battery Performance)

Table 1 shows the discharge capacity at the second cycle when a current of 1 mA/cm² is applied to batteries in Example 2 using lithium (Li), sodium (Na), potassium (K), magnesium (Mg), calcium (Ca), and aluminum (Al) as the counter electrode, as well as the discharge capacities after 10, 50, and 100 cycles, and the discharge capacities after two cycles when a current of 50 mA/cm² is applied.

As can be seen from Table 1, the hard carbon derived from bacteria-produced cellulose in Example 2 has excellent battery performance compared to the hard carbon in Example 1. This is considered to be because the hard carbon of Example 2 has a smaller fiber diameter and a larger specific surface area than the hard carbon of Example 1, allowing ions to be inserted and removed more smoothly, resulting in excellent charge/discharge characteristics.

Furthermore, the hard carbon of Example 2 is more elastic than the hard carbon of Example 1 and has excellent stretchability, which is considered to have controlled the decrease in capacity that accompanies expansion and contraction during charging and discharging.

### Example 3 and Example 4

Example 3 and Example 4 are hard carbons in which pressure was applied using a screw-type sealed crucible in the crystal growth step. The battery was produced and evaluated in a manner similar to that in Example 1.

### (Production of Hard Carbon)

In Example 3, amorphous carbon derived from cellulose nanofibers, as carried out in Example 1, was filled into a container portion of a screw-type sealed container, and pressure was applied to the amorphous carbon inside the container portion by closing the lid portion (inserting it inside the container) until the volume of the container portion was reduced to 1/10 of its original volume. Then, the screw-type sealed container in this state was subjected to a heat treatment in an argon gas atmosphere at 2500 °C for 30 minutes in a graphitization furnace (manufactured by KURATA GIKEN.). The other production conditions were the same as those in Example 1.

In Example 4, the bacteria-produced gel used in Example 2 is used instead of the cellulose nanofiber dispersion used in Example 3. The other production conditions were the same as those in Example 3.

### (Battery Performance)

Table 2 shows the discharge capacity at the second cycle when a current of 1 mA/cm² is applied to batteries using lithium (Li), sodium (Na), potassium (K), magnesium (Mg), calcium (Ca), and aluminum (Al) as the counter electrode, as well as the discharge capacities after 10, 50, and 100 cycles, and the discharge capacities after two cycles when a current of 50 mA/cm² is applied.

TABLE 2

| | | | | | | | | | Large | |
|---|---|---|---|---|---|---|---|---|---|---|
| | | | | | | | | | current | |
| | | | | | | | | | test | |
| | | | | | | | | | Current | |
| | | | | | | | | | density: | |
| | Counter | Cycle test Current density: 1 mA/cm² | | | | | | | 50 mA/cm² | |
| Example | electrode | 2 cycles | 10 cycles | | 50 cycles | | 100 cycles | | 2 cycles | |
| Example 3 | Li | 432 mAh/g | 426 | mAh/g | 417 | mAh/g | 394 | mAh/g | 344 | mAh/g |
| | Na | 417 mAh/g | 412 | mAh/g | 398 | mAh/g | 382 | mAh/g | 325 | mAh/g |
| | K | 368 mAh/g | 369 | mAh/g | 354 | mAh/g | 332 | mAh/g | 290 | mAh/g |
| | Mg | 158 mAh/g | 156 | mAh/g | 150 | mAh/g | 144 | mAh/g | 128 | mAh/g |
| | Ca | 148 mAh/g | 141 | mAh/g | 135 | mAh/g | 131 | mAh/g | 116 | mAh/g |
| | Al | 101 mAh/g | 98 | mAh/g | 95 | mAh/g | 90 | mAh/g | 74 | mAh/g |
| Example 4 | Li | 438 mAh/g | 430 | mAh/g | 426 | mAh/g | 405 | mAh/g | 379 | mAh/g |
| | Na | 421 mAh/g | 414 | mAh/g | 407 | mAh/g | 389 | mAh/g | 360 | mAh/g |
| | K | 389 mAh/g | 376 | mAh/g | 359 | mAh/g | 345 | mAh/g | 321 | mAh/g |
| | Mg | 161 mAh/g | 159 | mAh/g | 151 | mAh/g | 147 | mAh/g | 146 | mAh/g |
| | Ca | 157 mAh/g | 148 | mAh/g | 141 | mAh/g | 138 | mAh/g | 136 | mAh/g |
| | Al | 105 mAh/g | 102 | mAh/g | 99 | mAh/g | 93 | mAh/g | 79 | mAh/g |

It can be seen from Table 2 that the hard carbons of Example 3 and Example 4 have larger discharge capacities and better cycle characteristics than the hard carbons of Example 1 and Example 2 shown in Table 1. This is because the use of a screw-type sealed crucible in the crystal growth step allowed pressure to be applied in a well-controlled manner, which resulted in efficient growth of graphite crystals in the hard carbons of Example 3 and Example 4.

### Comparative Example 1 and Comparative Example 2

Comparative Example 1 and Comparative Example 2 are hard carbons produced through normal drying without performing the freezing step and the drying step of Example 1, and are hard carbons which were heat-treated without applying pressure in the crystal growth step. The battery was produced and evaluated in a manner similar to that in Example 1.

### (Production of Hard Carbon)

In Comparative Example 1, the cellulose nanofiber dispersion prepared in Example 1 was poured into a petri dish, placed in a thermostatic chamber, and dried at 60 °C for 12 hours. The cellulose nanofibers were then carbonized by calcining at 600 °C for 2 hours in a nitrogen atmosphere to obtain amorphous carbon derived from the cellulose nanofibers. The amorphous carbon was then heat-treated in an argon gas atmosphere in a graphitization furnace (manufactured by KURATA GIKEN.) at 2500 °C for 30 minutes to promote crystal growth, producing hard carbon derived from cellulose nanofibers. In this way, the hard carbon of Comparative Example 1 was produced.

In the method of Comparative Example 1, the amorphous carbon derived from cellulose nanofibers is highly brittle and would crack if pressure was applied. Therefore, in Comparative Example 1, the crystal growth step was carried out without applying pressure.

In Comparative Example 2, the bacteria-produced gel used in Example 2 is used instead of the cellulose nanofiber dispersion used in Comparative Example 1. The other production conditions were the same as those in Comparative Example 1.

### (Battery Performance)

Table 3 shows the discharge capacity at the second cycle when a current of 1 mA/cm² is applied to batteries using lithium (Li), sodium (Na), potassium (K), magnesium (Mg), calcium (Ca), and aluminum (Al) as the counter electrode, as well as the discharge capacities after 10, 50, and 100 cycles, and the discharge capacities after two cycles when a current of 50 mA/cm² is applied.

TABLE 3

| | | | | | | | | | | Large | |
|---|---|---|---|---|---|---|---|---|---|---|---|
| | | | | | | | | | | current | |
| | | | | | | | | | | test | |
| | | | | | | | | | | Current | |
| | | | | | | | | | | density: | |
| | Counter | Cycle test Current density: 1 mA/cm² | | | | | | | | 50 mA/cm² | |
| Example | electrode | 2 cycles | | 10 cycles | | 50 cycles | | 100 cycles | | 2 cycles | |
| Comparative | Li | 245 | mAh/g | 240 | mAh/g | 192 | mAh/g | 140 | mAh/g | 25 | mAh/g |
| Example 1 | Na | 130 | mAh/g | 126 | mAh/g | 100 | mAh/g | 74 | mAh/g | 19 | mAh/g |
| | K | 117 | mAh/g | 111 | mAh/g | 94 | mAh/g | 67 | mAh/g | 10 | mAh/g |
| | Mg | 43 | mAh/g | 42 | mAh/g | 35 | mAh/g | 24 | mAh/g | 3 | mAh/g |
| | Ca | 21 | mAh/g | 20 | mAh/g | 18 | mAh/g | 12 | mAh/g | 4 | mAh/g |
| | Al | 5 | mAh/g | 5 | mAh/g | 4 | mAh/g | 4 | mAh/g | 3 | mAh/g |
| Comparative | Li | 263 | mAh/g | 258 | mAh/g | 209 | mAh/g | 153 | mAh/g | 28 | mAh/g |
| Example 2 | Na | 209 | mAh/g | 204 | mAh/g | 164 | mAh/g | 120 | mAh/g | 20 | mAh/g |
| | K | 131 | mAh/g | 126 | mAh/g | 104 | mAh/g | 74 | mAh/g | 10 | mAh/g |
| | Mg | 49 | mAh/g | 48 | mAh/g | 40 | mAh/g | 26 | mAh/g | 3 | mAh/g |
| | Ca | 35 | mAh/g | 34 | mAh/g | 28 | mAh/g | 20 | mAh/g | 4 | mAh/g |
| | Al | 8 | mAh/g | 6 | mAh/g | 3 | mAh/g | 3 | mAh/g | 1 | mAh/g |

It can be seen from Table 3 that the hard carbons of Comparative Example 1 and Comparative Example 2 have smaller discharge capacities than the hard carbons of Example 1 and Example 2 shown in Table 1, and the cycle characteristics also show a large decrease in discharge capacity after the 50th cycle. This is because the hard carbons of Comparative Example 1 and Comparative Example 2 do not have a three-dimensional network structure because the freezing step and the drying step are not performed, making crystal growth possible; however, the particle size of the active material is large, and therefore the ion diffusion rate inside the active material is slow and the overvoltage is large. In addition, since this active material does not have stretchability, it is considered that the active material cannot withstand the expansion and contraction that accompanies charging and discharging, causing cracks and deactivation due to disconnection of the conductive paths.

### Comparative Example 3 and Comparative Example 4

Comparative Example 3 and Comparative Example 4 are hard carbons produced through a heat treatment without applying pressure in the crystal growth step of Example 1. The battery was produced and evaluated in a manner similar to that in Example 1.

In Comparative Example 3, a heat treatment was carried out in a graphitization furnace (manufactured by KURATA GIKEN.) at 2500 °C for 30 minutes in an argon gas atmosphere without placing a graphite plate of a weight that would make the thickness of the amorphous carbon derived from cellulose nanofibers 1/10 as heavy as that of Example 1. The other production conditions were the same as those in Example 1.

In Comparative Example 4, the bacteria-produced gel used in Example 2 is used instead of the cellulose nanofiber dispersion used in Comparative Example 3. The other production conditions were the same as those in Comparative Example 3.

### (Battery Performance)

Table 4 shows the discharge capacity at the second cycle when a current of 1 mA/cm² is applied to batteries using lithium (Li), sodium (Na), potassium (K), magnesium (Mg), calcium (Ca), and aluminum (Al) as the counter electrode, as well as the discharge capacities after 10, 50, and 100 cycles, and the discharge capacities after two cycles when a current of 50 mA/cm² is applied.

TABLE 4

| | | | | | | Large |
|---|---|---|---|---|---|---|
| | | | | | | current |
| | | | | | | test |
| | | | | | | Current |
| | | | | | | density: |
| | Counter | Cycle test Current density: 1 mA/cm² | | | | 50 mA/cm² |
| Example | electrode | 2 cycles | 10 cycles | 50 cycles | 100 cycles | 2 cycles |
| Comparative | Li | 4 mAh/g | 4 mAh/g | 4 mAh/g | 4 mAh/g | 0.3 mAh/g |
| Example 3 | Na | 5 mAh/g | 5 mAh/g | 5 mAh/g | 4 mAh/g | 0.3 mAh/g |
| | K | 5 mAh/g | 5 mAh/g | 4 mAh/g | 4 mAh/g | 0.4 mAh/g |
| | Mg | 3 mAh/g | 3 mAh/g | 3 mAh/g | 2 mAh/g | 0.3 mAh/g |
| | Ca | 3 mAh/g | 3 mAh/g | 3 mAh/g | 3 mAh/g | 0.3 mAh/g |
| | Al | 4 mAh/g | 4 mAh/g | 4 mAh/g | 3 mAh/g | 0.3 mAh/g |
| Comparative | Li | 5 mAh/g | 5 mAh/g | 5 mAh/g | 5 mAh/g | 0.4 mAh/g |
| Example 4 | Na | 4 mAh/g | 4 mAh/g | 4 mAh/g | 4 mAh/g | 0.3 mAh/g |
| | K | 5 mAh/g | 5 mAh/g | 5 mAh/g | 3 mAh/g | 0.4 mAh/g |
| | Mg | 3 mAh/g | 3 mAh/g | 3 mAh/g | 3 mAh/g | 0.3 mAh/g |
| | Ca | 3 mAh/g | 3 mAh/g | 3 mAh/g | 3 mAh/g | 0.3 mAh/g |
| | Al | 3 mAh/g | 2 mAh/g | 3 mAh/g | 2 mAh/g | 0.3 mAh/g |

It can be seen from Table 4 that the carbon materials produced in Comparative Example 3 and Comparative Example 4 do not function as negative electrodes for ion batteries.

This is because no pressure was applied during the crystal growth step, which resulted in insufficient crystal growth and the lack of a layered structure of connected six-membered carbon rings like graphite, which meant that ions could not be inserted and removed between the layers of the six-membered carbon rings.

### Comparative Example 5

In Comparative Example 5, evaluation was performed using commercially available hard carbon as the negative electrode active material. The method for producing and evaluating the battery was the same as in Example 1, except that commercially available hard carbon (manufactured by KUREHA CORPORATION) was used as the hard carbon. Commercially available hard carbon is a non-graphitizable carbon.

### (Battery Performance)

Table 5 shows the discharge capacity at the second cycle when a current of 1 mA/cm² is applied to batteries using lithium (Li), sodium (Na), potassium (K), magnesium (Mg), calcium (Ca), and aluminum (Al) as the counter electrode, as well as the discharge capacities after 10, 50, and 100 cycles, and the discharge capacities after two cycles when a current of 50 mA/cm² is applied.

TABLE 5

| | | | | | | | | | | Large | |
|---|---|---|---|---|---|---|---|---|---|---|---|
| | | | | | | | | | | current | |
| | | | | | | | | | | test | |
| | | | | | | | | | | Current | |
| | | | | | | | | | | density: | |
| | Counter | Cycle test Current density: 1 mA/cm² | | | | | | | | 50 mA/cm² | |
| Example | electrode | 2 cycles | | 10 cycles | | 50 cycles | | 100 cycles | | 2 cycles | |
| Comparative | Li | 350 | mAh/g | 342 | mAh/g | 276 | mAh/g | 203 | mAh/g | 34 | mAh/g |
| Example 5 | Na | 245 | mAh/g | 239 | mAh/g | 192 | mAh/g | 141 | mAh/g | 23 | mAh/g |
| | K | 231 | mAh/g | 224 | mAh/g | 181 | mAh/g | 132 | mAh/g | 21 | mAh/g |
| | Mg | 125 | mAh/g | 121 | mAh/g | 96 | mAh/g | 74 | mAh/g | 10 | mAh/g |
| | Ca | 109 | mAh/g | 104 | mAh/g | 84 | mAh/g | 60 | mAh/g | 7 | mAh/g |
| | Al | 81 | mAh/g | 79 | mAh/g | 60 | mAh/g | 44 | mAh/g | 4 | mAh/g |

It can be seen from Table 5 that the hard carbon of Comparative Example 5 has a smaller discharge capacity than the hard carbons of Example 1 and Example 2 shown in Table 1, and the cycle characteristics also show a large decrease in discharge capacity after the 50th cycle. These results show that the hard carbon derived from cellulose nanofibers and the hard carbon derived from bacteria-produced cellulose in Example 1 and Example 2 have excellent battery performance. In other words, the hard carbons of Example 1 and Example 2 have a three-dimensional network structure, maintain conductive paths between the active materials having stretchability, and enable an improvement in the diffusion rate of lithium ions absorbed onto the surface of the active material. Furthermore, the structure is not destroyed by the expansion and contraction that accompanies the insertion and removal of ions during charging and discharging, and therefore, it is found to have excellent battery performance.

The method for producing hard carbon of the present embodiment described above includes: freezing a dispersion or gel containing cellulose nanofibers to obtain a frozen body; drying the frozen body in a vacuum to obtain a dried body; heating and carbonizing the dried body in a non-combustible atmosphere to obtain amorphous carbon derived from cellulose nanofibers; and heating the amorphous carbon in a non-combustible atmosphere while applying pressure to grow graphite crystals to obtain hard carbon derived from cellulose nanofibers.

According to the present embodiment, hard carbon with maintained conductive paths can be produced by using cellulose nanofibers, which is a plant-derived material with low resource risk. That is, according to the present embodiment, it is possible to produce hard carbon that is prevented from decreasing in charge/discharge capacity and has excellent cycle characteristics and high-speed charge/discharge characteristics.

Therefore, the ion battery using the hard carbon of the present embodiment can be effectively used as a new drive source for various electronic devices such as small devices, sensors, and mobile devices.

Note that the present disclosure is not limited to the above embodiments, and various modifications and combinations are possible within the technical idea of the present disclosure.

### REFERENCE SIGNS LIST

S1 Dispersion step
S2 Freezing step
S3 Drying step
S4 Carbonization step
S5 Crystal growth step
S11 Gel generation step
S12 Freezing step
S13 Drying step
S14 Carbonization step
S15 Crystal growth step
101 Positive electrode
102 Electrolytic solution
103 Negative electrode
201 Positive electrode case
202 Negative electrode case
203 Propylene gasket

1. A method for producing hard carbon, the method comprising:
freezing a dispersion or gel containing cellulose nanofibers to obtain a frozen body;
drying the frozen body in a vacuum to obtain a dried body;
heating and carbonizing the dried body in a non-combustible atmosphere to obtain amorphous carbon derived from cellulose nanofibers; and
heating the amorphous carbon in a non-combustible atmosphere while applying pressure to grow graphite crystals to obtain hard carbon derived from cellulose nanofibers.

2. The method for producing hard carbon according to claim 1, wherein
the cellulose nanofibers are dispersed using bacteria to generate the gel.

3. The method for producing hard carbon according to claim 1, wherein,
in the growth of the crystals, graphite is placed on the amorphous carbon, and the pressure is applied to the amorphous carbon.

4. The method for producing hard carbon according to claim 1, wherein,
in the growth of the crystals, the pressure is applied to the amorphous carbon using a screw-type sealed crucible.

5. A hard carbon comprising:
a three-dimensional network structure in which cellulose nanofibers are branched and connected cocontinuously; and
a hexagonal plate-like layered crystal structure of carbon into which ions are insertable and removable.

6. A hard carbon comprising:
a three-dimensional network structure in which cellulose nanofibers of a bacteria-produced gel are branched and connected cocontinuously; and
a hexagonal plate-like layered crystal structure of carbon into which ions are insertable and removable.
